(19) United States
(12) Patent Application Publication
(10) Pub. No.: US 2020/0088148 A1
(43) Pub. Date: Mar. 19, 2020

(54) DIESEL INJECTORS AND METHOD OF MANUFACTURING DIESEL INJECTORS

(71) Applicant: Ford Global Technologies, LLC, Dearborn, MI (US)

(72) Inventors: Carl Stephen Newman, Colchester (GB); Graham Michael Kudar, Chelmsford (GB)

(21) Appl. No.: 16/572,467

(22) Filed: Sep. 16, 2019

(30) Foreign Application Priority Data
Sep. 18, 2018 (GB) 1815156.3

(51) Int. Cl. F02M 61/18; F02M 61/16; F02M 61/14; B23C 3/00

(52) U.S. Cl. CPC F02M 61/1806; F02M 61/168; F02M 2200/05; F02M 61/14; B23C 3/00; F02M 61/166

(57) ABSTRACT

Methods and systems are provided for a diesel fuel injector for an internal combustion engine is provided. The diesel fuel injector comprises an injector nozzle body, the injector nozzle body comprising a first thickness of material, wherein an injection passage for injecting fuel using the fuel injector is formed in the first thickness of material, the injection passage defining an opening through which fuel is sprayed from the injector; and a second thickness of material, wherein the second thickness of material forms an outer surface of the injector nozzle body and wherein the second thickness of material extends around the injection passage, spaced apart from the injection passage opening, such that condensation forming on the outer surface of the injector nozzle body is positioned away from the opening of the injection passage. A method of manufacturing a diesel fuel injector is also provided.

### CROSS REFERENCE TO RELATED APPLICATIONS

The present application claims priority to United Kingdom Patent Application No. 1815156.3, filed on Sep. 18, 2018. The entire contents of the above-listed application is hereby incorporated by reference for all purposes.

### FIELD

The present description relates generally to diesel injectors with corrosion resistance.

### BACKGROUND/SUMMARY

In order to meet emissions requirements, engine assemblies are employing increasing amounts of exhaust gas recirculation. In particular, engine assemblies may begin recirculating exhaust gases soon after the engine has been started, and recirculate a greater amount of the exhaust gases than older engine assemblies.

If an engine is started and subsequently shut down before the engine has been running for a sufficiently long time for the engine to reach a suitable running temperature, condensation can form on the internal surfaces of an engine cylinder. This may include condensate formation on the fuel injector. This issue may be especially pronounced in diesel engines, where combustion temperatures are lower, and therefore the engine may take longer to reach the suitable running temperature.

Due to the increased amount of exhaust gas recirculation being employed sooner after the engine has been started, the condensates that form on the fuel injector can contain increased amounts of acidic compounds from the exhaust gases. The increased acidity of the condensates can lead to corrosion of openings of the injection passages. The size and shape of the openings may control the rate at which fuel is injected in to the cylinder, and the size and dispersion, (e.g., atomization) of fuel droplets that are injected. Corrosion of the fuel injection openings can therefore lead to reduced performance of the engine in terms of torque and/or fuel economy.

In one example, sulfur trioxide may form from a reaction between sulfur from the fuel and oxygen in the combustion reaction materials. Water may react with the sulfur trioxide, which may form sulfuric acid, a corrosive agent. Sulfuric acid may condense at temperatures near 150° C., which may be lower than the suitable running temperatures. As such, if the engine and its components are not heated beyond the dew point temperature of sulfuric acid, in one example, then sulfuric acid may condensate on combustion chamber surfaces and fuel injector surfaces, and degrade the surfaces on which it condenses.

In one example, the issues described above may be addressed by a diesel fuel injector for an internal combustion engine, the diesel fuel injector comprising an injector nozzle body comprising a first thickness of material with at least one of an injection passage shaped therein and configured to expel fuel to a combustion chamber, the first thickness of material is configured to contain fuel at an injection pressure of the diesel fuel injector and a second thickness of material arranged around only portions of the first thickness of material where the injection passage is located, the second thickness of material comprising a clearance hole shaped to allow fuel to flow therethrough.

As one example, the second thickness of material may be a sacrificial material on the injector nozzle body. The second thickness of material may be shaped to capture condensate to block condensate formation on the first thickness of material where the injection passages are shaped. By providing the second thickness of material in addition to the first thickness of material, wherein the first thickness of material is configured for structurally containing fuel within an injector sac at an injection pressure, degradation of the first thickness of material where the fuel injection passages are formed may be mitigated.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

FIG. 1 shows a schematic view of a diesel engine assembly for a motor vehicle.

FIGS. 2A and 2B show schematic, sectional views of a diesel fuel injector of a previous example for an engine assembly before and after a period of use within the engine assembly of FIG. 1.

FIGS. 3A and 3B show schematic, sectional views of a diesel fuel injector, according to the present disclosure, before and after a period of use within the engine assembly of FIG. 1.

FIG. 4 shows a flow chart illustrating a method of manufacturing a diesel fuel injector according to the present disclosure, such as the diesel fuel injector of FIGS. 3A and 3B.

### DETAILED DESCRIPTION

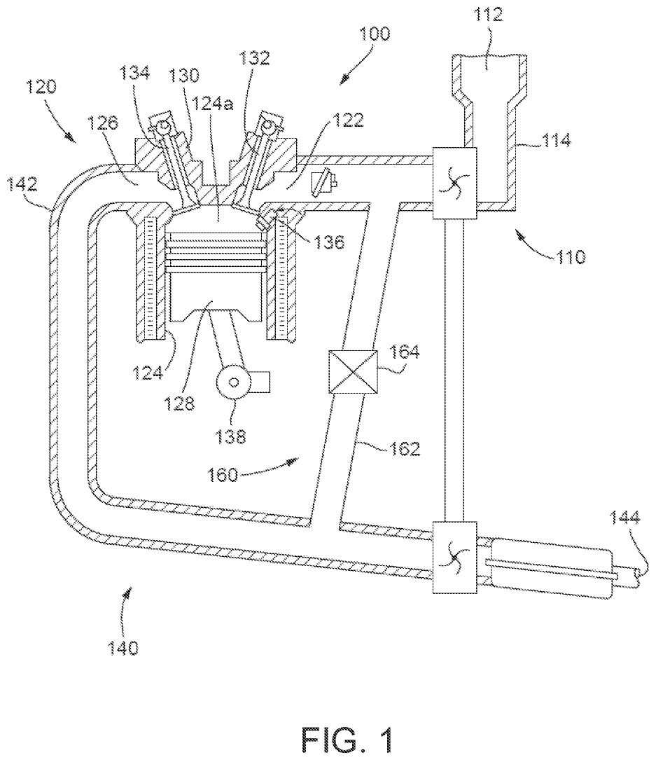

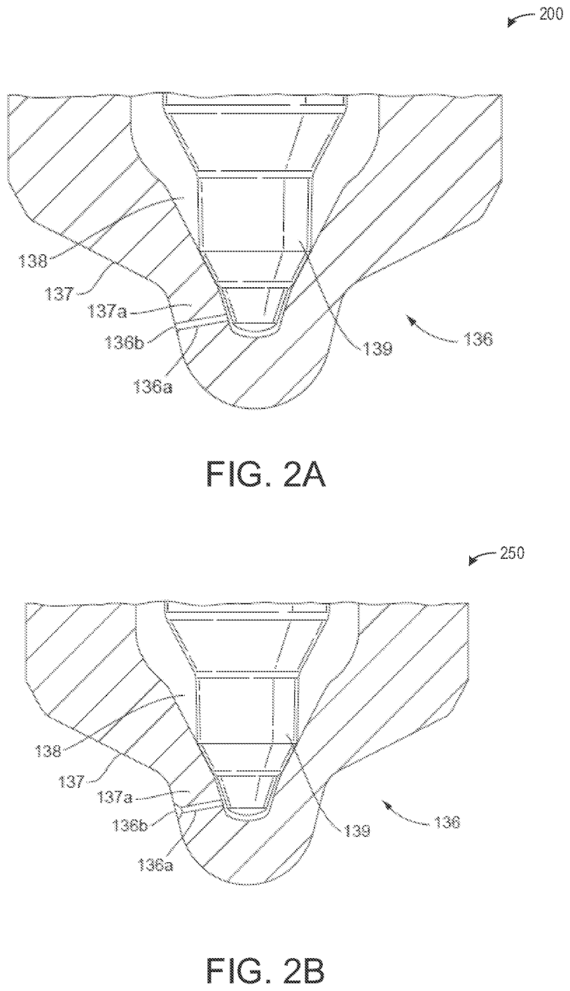

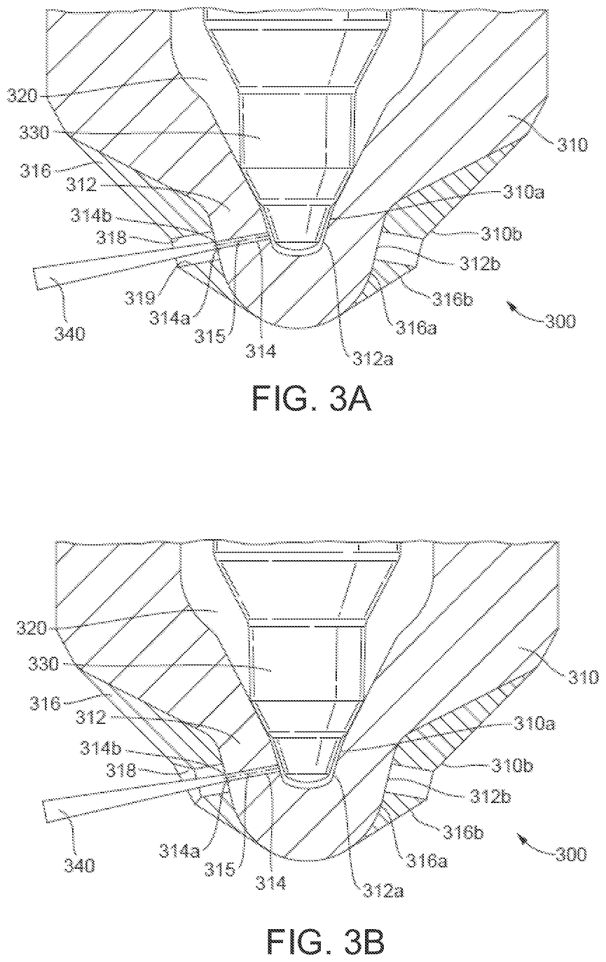

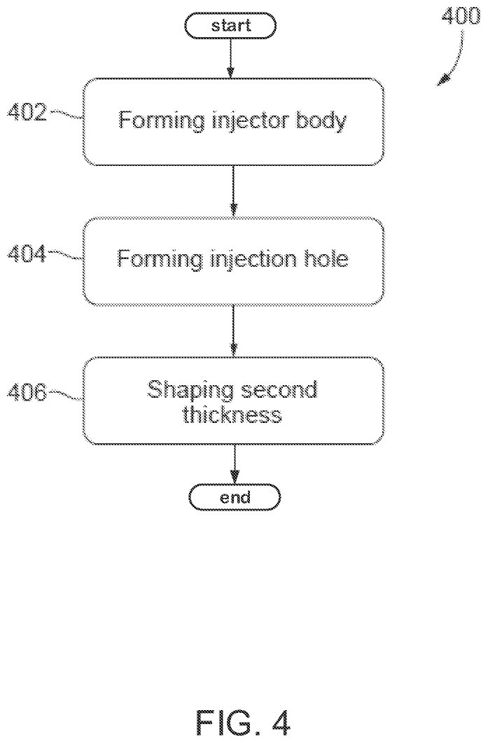

The following description relates to systems and methods for a fuel injector. FIG. 1 shows a schematic view of a diesel engine assembly for a motor vehicle. FIGS. 2A and 2B show schematic, sectional views of a diesel fuel injector of a previous example for an engine assembly before and after a period of use within the engine assembly of FIG. 1. FIGS. 3A and 3B show schematic, sectional views of a diesel fuel injector, according to the present disclosure, before and after a period of use within the engine assembly of FIG. 1. FIG. 4 shows a flow chart illustrating a method of manufacturing a diesel fuel injector according to the present disclosure, such as the diesel fuel injector of FIGS. 3A and 3B.

According to another aspect of the present disclosure, there is provided a diesel fuel injector for an internal combustion engine, the diesel fuel injector comprising an injector nozzle body, the injector nozzle body comprising a first thickness of material, wherein an injection passage for injecting fuel using the fuel injector is formed in the first thickness of material, the injection passage defining an opening through which fuel is sprayed from the injector and a second thickness of material, wherein the second thickness of material forms an outer surface of the injector nozzle body and wherein the second thickness of material extends around the injection passage, spaced apart from the injection passage opening, in a direction perpendicular to a central axis of the injection passage, such that condensation forming on the outer surface of the injector nozzle body is positioned away from the opening of the injection passage.

The injector nozzle body (e.g. the first thickness of material) may define an interior space of the fuel injector. The second thickness of material may be provided over (e.g. outside of) the first thickness of material, relative to the interior space of the injector nozzle body. In one example, the injector nozzle body of the present disclosure does not include an upper portion of the injector and includes only the nozzle body from which fuel is sprayed. In one example, the injector nozzle body protrudes into the combustion chamber.

The second thickness of material may be positioned on the injector nozzle body such that condensation forming on the injector nozzle body forms on the second thickness rather than the first thickness (e.g. at the injection passage opening).

The second thickness of material may be shaped (e.g. around the injection passage opening) such that an injection of fuel from the fuel injector is substantially unaffected/unimpeded by the second thickness of material.

The second thickness of material may define a clearance hole extending through the second thickness of material. The clearance hole may be aligned with the injection passage. The clearance hole may have a greater diameter than the injection passage, and may have a greater diameter than a spray of fuel injected via the injection passage, at the position that the spray passes the outer surface of the injector nozzle body. In other words, the diameter of the clearance hole may be greater than a diameter of a spray of fuel passing though the clearance hole. The diameter of the clearance hole may be selected based on an angle of the spray of fuel leaving the injection passage and the thickness of the second thickness. In this way, the spray of fuel may be substantially unimpeded or unaffected by the presence of the second thickness of material. In one example, the fuel spray may not contact interior surfaces of the clearance hole shaped within the second thickness of material.

The injection passage and the second thickness of material may together be configured such that performance of the fuel injector is substantially unaffected by corrosion of the outer surface of the injector nozzle body.

The first and second thicknesses of material may be integrally formed. The first and second thicknesses of material may be formed from the same material. Alternatively, the first and second thicknesses of material may comprise layers and/or may comprise different materials. In one embodiment, the second thickness of material is an additional material added to the first thickness of material, such that the two thicknesses of materials are distinct from one another. By doing this, replacement of the second thickness of material following degradation due to condensate formation may be relatively easy and fast.

The first and second thicknesses of material may be formed by the same manufacturing process, such as a forging or casting process. Alternatively, the second thickness of material may be formed onto the first thickness of material in a separate manufacturing process (e.g. to a manufacturing process by which the first thickness is formed). In one example, the second thickness of material is added to the first thickness of material via additive manufacturing.

A sharp edge (e.g. free of chamfers and fillets) may be formed at an opening of the injection passage. The sharp edge may be configured such that a spray of fuel is formed by the fuel leaving the opening. A chamfered or filleted edge may be formed at an opening of the clearance hole. In one example, the sharp edge is oriented normal to an axis along which the spray is injected.

The depth and/or diameter of the injection passage may be configured such that a desired flow rate of fuel can be injected during a fuel injection event. The thickness of the first thickness of material may be equal to the depth of the injection passage.

The second thickness of material may be shaped such that the second thickness is degraded (e.g., corroded) by corrosive condensates forming on the injector nozzle body in preference to the first thickness of material (e.g. in preference to the opening of the injector hole in the first thickness). Thus, in one embodiment, the second thickness of material may be a sacrificial material configured to degrade in response to condensate formation, which may be due to EGR or other combustion chamber additives, while blocking condensate formation on the first thickness of material. In this way, a fuel injection rate and angle may not be affect due to the first thickness of material degrading due to condensate formation. Furthermore, the second thickness of material, which is arranged outside of the first thickness of material and exposed to combustion chamber conditions, may be easily replaced and/or repaired in the event of its degradation.

The fuel injector may further comprise a layer of corrosion resistant material formed on the outer surface of the injector nozzle body.

According to an aspect of the present disclosure, there is provided a diesel fuel injector for an internal combustion engine, the diesel fuel injector comprising an injector nozzle body, the injector nozzle body comprising a first thickness of material, wherein an injection passage for injecting fuel using the fuel injector is formed in the first thickness of material and a second thickness of material, wherein the second thickness of material forms an outer surface of the injector nozzle body and wherein the second thickness of material extends around the injection passage formed in the first thickness such that injection of fuel by the fuel injector is substantially unimpeded by the second thickness.

Condensation forming on the injector nozzle body may thereby form on the second thickness of material and positioned away from the opening of the injection passage.

According to another aspect of the present disclosure, there is provided a method of manufacturing a diesel fuel injector, the method comprising forming an injector nozzle body, the injector nozzle body comprising a first thickness of material and a second thickness of material, wherein the second thickness of material forms an outer surface of the injector nozzle body, forming an injection passage for injecting fuel using the fuel injector though the first thickness of material, shaping the second thickness of material, such that the second thickness of material is spaced apart from the injection passage opening and condensation forming on the outer surface of the injector nozzle body is positioned away from the opening of the injection passage.

Shaping the second thickness of material may comprise forming a clearance hole though the second thickness of material. The clearance hole may be aligned with the injection passage.

The clearance hole may have a greater diameter than a spray of fuel injected via the injection passage where (e.g. at the position that) the spray passes the outer surface of the injector nozzle body.

The injection passage may be formed such that a sharp edge is formed at an opening of the injection passage for forming a spray of fuel.

The method may further comprise forming a layer of corrosion resistant material on the outer surface of the injector nozzle body.

With reference to FIG. 1, a diesel engine assembly 100 for a motor vehicle comprises an intake system 110, an engine 120 and an exhaust system 140.

The intake system 110 comprises an air inlet 112 and an intake duct 114. During operation of the engine 120, air is drawn into the intake system 110 via the air inlet 112 and carried to an inlet manifold 122 of the engine 120 by the intake duct 114.

The engine 120 comprises the inlet manifold 122, a cylinder 124, and an outlet manifold 126. A piston 128 is provided within the cylinder 124 and is configured to reciprocate within the cylinder 124 during a combustion cycle of the engine 120. A combustion chamber 124a of the cylinder 124 is defined by one side of the piston 128, the walls of the cylinder 124, and a cylinder head 130.

The engine 120 further comprises one or more inlet valves 132 and one or more exhaust valves 134 to control the flow of inlet and exhaust gases into and out of the cylinder 124 respectively.

During an intake stroke, the piston 128 moves within the cylinder 124 to increase the volume of the combustion chamber 124a, drawing inlet gases from the inlet manifold 122 into the cylinder via the inlet valves 132. Following the intake stroke, the inlet valve 132 is closed and the gases within the cylinder 124 are compressed as the piston 128 moves back towards the cylinder head 130, reducing the volume of the combustion chamber 124a.

Fuel, e.g. diesel fuel, is injected into the cylinder 124 via one or more fuel injectors, such as direct injection fuel injectors 136 and the air and fuel mixture is ignited by virtue of the high pressure and temperature within the combustion chamber 124a. Combustion of the air and fuel mixture produces expanding combustion gases that act against the piston 128 to drive a crank shaft 138 of the engine 120.

The timing with which fuel is injected into the cylinder 124, and the amount of fuel injected relative to the amount of inlet air, may affect the power and/or torque produced by the engine 120.

The timing and amount of fuel being injected may also affect the efficiency at which the engine 120 is operation. Additionally, power, torque and/or efficiency of the engine may be affected by the size of droplets of fuel injected into the cylinder 124 by the injector 136, and the extent to which the fuel droplets are dispersed within and mixed with the inlet gases within the combustion chamber 124a.

With reference to FIG. 2A, an embodiment 200 of the fuel injector 136 of FIG. 1 is illustrated in greater detail. In order to control the size of the fuel droplets injected by the fuel injector 136, the extent to which the fuel droplet is dispersed, the fuel injector 136 may comprise one or more fuel injection passages 136a that are configured to control the injection of fuel into the cylinder. As depicted, the fuel injection passages extend through a wall 137a of a body portion 137 of the fuel injector into an interior space 138 defined by the body portion 137. Fuel is held within the interior space 138 before being injected into the cylinder 124.

The fuel injector 136 further comprises a needle 139 provided within the interior space 138. The needle 139 is configured to selectively block the injection passage 136a from the interior space 138, in order to control the injection of fuel from the interior space 138 into the cylinder 124.

During an injection event, the needle 139 unblocks the injection passage 136a and pressurized fuel within the interior space 138 passes through the injection passage 136 into the cylinder 124. A diameter and a length of the injection passage 136 are selected such that a desired flow rate of fuel is allowed to flow from the interior space 138 to the cylinder 124 during the injection event.

An opening 136b of the injection passage 136a into the cylinder is shaped such that a spray of fuel is created from the injection passage 136a into the cylinder 124. In particular, a sharp corner, e.g. which is free from chamfers, is formed at the opening 136b. By spraying the fuel from the one or more injection passages 136a of the selected diameter, the size of droplets of fuel within the cylinder and the dispersion of droplets can be controlled as desired.

Returning to FIG. 1, during an exhaust stroke of the piston 128, exhaust gases produced through the combustion within the cylinder 124 are exhausted from the cylinder 124 into the exhaust manifold 126 via the exhaust valve 134.

An exhaust duct 142 of the exhaust system 140 is arranged to carry the exhaust gases from the exhaust manifold 124 to an exhaust outlet 144 to be emitted from the vehicle.

The engine assembly 100 may further comprise an Exhaust Gas Recirculation (EGR) system 160. The EGR system 160 comprises an EGR duct 162 configured to recirculate a portion of the exhaust gases to the intake system 110 of the engine assembly 100 (e.g. to the intake duct 114 or to the inlet manifold 122). The EGR system 160 further comprises an EGR valve 164 configured to control the flow of exhaust gases through the EGR duct 162.

Replacing a portion of the oxygen rich inlet air within the engine cylinder 124 with burnt exhaust gases reduces the volume of the combustion chamber 124a that is available for combustion. This reduces the peak temperature of combustion, thereby reducing the formation of NOR.

In order to meet emissions requirements, modern engine assemblies are employing increasing amounts of exhaust gas recirculation. In particular, modern engine assemblies typically begin recirculating exhaust gases sooner after the engine has been started, and recirculate a greater amount of the exhaust gases than older engine assemblies.

If a diesel engine is started and subsequently shut down before the engine 120 has been running for a sufficiently long time for the engine to reach a suitable running temperature, condensation can form on the internal surfaces of the engine cylinder 124. In particular, condensation can form on the fuel injector 136.

Due to the increased amount of exhaust gas recirculation being employed sooner after the engine has been started, the condensates that form on the fuel injector can contain increased amounts of acidic compounds from the exhaust gases. As depicted in FIG. 2B, the increased acidity of the condensates can lead to degradation (e.g., corrosion) of the openings 136b of the injection passages 136A as shown in the embodiment 250. As described above, the size and shape of the openings 136b may control the rate at which fuel is injected to the cylinder 124, and the size and dispersion (e.g. atomization) of fuel droplets that are injected. Corrosion of the fuel injection openings can therefore lead to reduced performance of the engine in terms of torque and/or fuel economy. In one embodiment, the injection passages are warped and/or misshapen following the degradation such that the fuel injection rate, fuel injection angle, and/or fuel injection mixing. Thus, the degradation may also lead to decreased engine power output and decreased fuel economy.

With reference to FIGS. 3A and 3B, a fuel injector, such as diesel fuel injector 300, according to arrangements of the present disclosure, comprises an injector nozzle body 310 that defines an interior space 320 of the fuel injector in which fuel is held at an injection pressure before being injected. The fuel injector 300 further comprises a needle 330 movable within the interior space to control the operation of the injector 300. In one example, diesel fuel injector 300 may be used in the embodiment of FIG. 1 in place of the fuel injector 136.

The injector nozzle body 310 comprises a first thickness of material 312, which may be interchangeably referred to herein as a first material 312. The first thickness of material 312 extends outwardly, relative to the interior space 320, from an inner extent 312a of the first thickness of material to an outer extent 312b of the first thickness of material. The inner extent 312a defines an inner surface 310a of the injector nozzle body 310, which at least partially defines the interior space 320 of the fuel injector 300. In this way, pressurized fuel in the interior space 320 may contact a portion of the inner extent 312a.

A thickness of the first thickness 312 of material (e.g. a dimension defined between the inner and outer extents 312a, 312b of the first thickness 312), may be determined based on the pressure of fuel to be held within the interior space 320. In particular, the first thickness 312 of material may be configured to structurally contain the fuel at the injection pressure without the injector nozzle body 310 deforming more than a threshold amount (e.g. according to limits and/or tolerances generally accepted in the art of fuel injector design).

An injection passage 314 of the fuel injector 300 is formed though the first thickness 312 of material. The injection passage 314 extends from the interior space 320 to an opening 314a through which fuel can be injected. The opening 314a of the injection passage may be formed at the outer extent 312b of the first thickness of material. The injection passage 314 may be similar to the injection passage 136a described above with reference to FIGS. 2A and 2B. The injection passage 136a may be formed so that a diameter and length of the injection passage permit a desirable flow rate of fuel to flow from the interior space 320 to the opening 314a during an injection event. The thickness of the first thickness of material 312 may be equal to the length of the injection passage 314.

Additionally, the opening 314a of the injection passage 314 is formed such that a spray 340 of fuel is projected from the injection passage 314 during the injection event. In particular, as described above, a sharp corner 314b (e.g. free from chamfers and fillets) is formed at the opening 314a. In one example, the sharp corner 314b comprises a shape that is perpendicular to an axis of injection.

The fuel injector nozzle body 310 further comprises a second thickness of material 316. The second thickness of material 316 is formed over the first thickness of material 312. In other words, the second thickness of material 316 is formed outwardly of the first thickness of material 312 relative to the interior space 320. As shown, the second thickness of material 316 extends outwardly from an inner extent of the second thickness of material 316a, which is formed at or directly adjacent to and in face-sharing contact with the outer extent 312b of the first thickness of material 312, to an outer extent 316b of the second thickness of material 316. The outer extent 316b of the second thickness of material 316 forms at least part of an outer surface 310b of the injector nozzle body 310. In one example, the outer extent 316b may be in face-sharing contact with combustion chamber materials, additives, and byproducts, such as air, EGR, fuel, CO₂, NOR, and the like.

As depicted in FIG. 3A, the second thickness of material 316 extends around the opening 314a of the injection passage 314 and is spaced apart from the opening 314a. In particular, the second thickness of material 316 is spaced apart from the opening 314a of the injection passage 314 in a direction perpendicular to a central axis 315 (e.g., the axis of injection) of the injection passage 314 at the outer extent 312b of the first thickness of material 312.

The second thickness of material 316 may be shaped around the injection passage opening such that injection of fuel by the fuel injector is substantially unimpeded by the second thickness. For example, the second thickness of material 316 may define a clearance hole 318 extending through the second thickness of material. The clearance hole 318 may be aligned within the injection passage 314 and the clearance hole 318 may have a greater diameter than the injection passage. Hence, surfaces 319 defining the clearance hole 318 are spaced apart from the opening 314a in a radial direction of the injection passage. In one example, the central axis 315 is a central axis for each of the clearance hole 318 and the injection passage 314. The clearance hole 318 may be shaped such that fuel ejected from the injection passage 314 does not contact surface 319 of the clearance hole 318. As such, the clearance hole 318 does not adjust a fuel injection rate, angle, and/or shape.

In the example depicted in FIG. 3A, the clearance hole 318 is substantially circular in cross-section. However, in other arrangements, the clearance hole 318 may be other shapes, such as square, triangular, or hexagonal in cross-section. Furthermore, the cross-sectional shape of the clearance hole may change along the length of the clearance hole, e.g. between the inner and outer extents 316a, 316b of the second thickness of material. In one example, the clearance hole 318 may comprise a square cross-section shape near the inner extent 316a and a circular cross-section near the outer extent 316b.

The clearance hole 318 may be sized and shaped such that the spray 340 of fuel injected through the injection passage is not impeded by the clearance hole 318. In one example, the shape of the clearance hole is such that the spray 340 of fuel injected through the injection passage does not impinge on the surfaces 319 defining the clearance hole. For example, the clearance hole 318 may have a diameter equal to or greater than a diameter of the spray 340 where, e.g. at the position that, the spray passes the outer surface 310b of the injector nozzle body. In one example, the outer surface 310b of the injector nozzle body corresponds to the outer extent 316b of the second thickness of material 316.

With reference to FIG. 3B, if condensation forms on the inside surfaces of the cylinder 124 during operation of the engine assembly, condensation may form on the outer surface 310b of the fuel injector nozzle body 310. Condensation may therefore form on the second thickness of material 316. As shown in FIG. 3B, the second thickness of material 316 may become degraded (e.g., corroded) due to the presence of acidic condensation forming on the second thickness of material 316. In particular, the clearance hole 318 may be corroded. In some arrangements, the second thickness of material 316 may be shaped to encourage condensation to form on the second thickness of material 316 (e.g. on the outer surface 310b of the injector nozzle body 310 formed by the second thickness of material). The second thickness of material 316 may comprise a shape that encourages condensate to form thereto while blocking and/or minimizing the likelihood of condensate flowing through the clearance hole 318 and forming on the first thickness of material 312. In one example, the second thickness of material 316 comprises one or more features that impedes the flow of condensate from entering the clearance hole 318 without affecting or contacting the fuel injection spray 340.

As described above, the injection passage 314 is formed in the first thickness of material 312, and the second thickness of material 316 is spaced apart from the opening 314a of the injection passage 314 by an amount equal to a diameter of the clearance hole 318. Hence, condensation may not form at the opening 314a of the injection passage 314. The shape of the opening 314a of the injection passage may therefore be unaffected following corrosion of the outer surface 310a of the injector nozzle body 310. In particular, the sharp corner at the opening 314 of the injection passage 316 may be maintained. Furthermore, because the clearance hole 318 has a greater diameter than the injection passage 314, the position at which condensation can form on the outer surface 310b of the second thickness of material 316 is further from the central axis 315 of the injection passage 314 than an edge of the opening of the injection passage. Hence, corrosion of the injection passage may be reduced. Deterioration in the performance of the injector 300 due to corrosion of the outer surface 310b may therefore be reduced. In some arrangements, performance of the injector 300 may be substantially unaffected following corrosion of the outer surface 310b.

In the arrangement shown in FIGS. 3A and 3B, the first and second thicknesses of material 312, 316 are formed from the same material. The first and second thicknesses of material 312, 316 are integrally formed. Furthermore, the first and second thicknesses of material may be formed through the same manufacturing process. For example, the injector nozzle body 310 including the first and second thicknesses of material 312, 316 may be formed through a casting or forging process.

In alternative arrangements, the first and second thicknesses of material 312, 316 may comprise layers of the same or different materials, which may be formed by different manufacturing steps. For example, the first thickness of material 312 may be formed using a first manufacturing process, and the second thickness of material 316 may be formed over the first thickness of material 312 using a second manufacturing process. In one example, the second thickness of material 316 is welded, fused, etc. to the first thickness of material 312. Additionally or alternatively, the second thickness of material 316 may be layered onto the first thickness of material 312 via additive manufacturing.

The second thickness of material may be formed from a corrosion resistant material. In other arrangements, a coating or corrosion resistant material may be applied to the outer surface of the injector nozzle body (e.g. at the outer extent of the second thickness of material 316b). In one example, the corrosion resistant material may be arranged on only the second thickness of material 316 and not on the first thickness of material 312. Additionally or alternatively, the second thickness of material 316 may comprise a material that reaches a dew point temperature more quickly than a material of the first thickness of material 312. As such, condensate may preferentially form on the second thickness of material 316 than the first thickness of material 312. Additionally or alternatively, the material may be ceramic or the like, wherein a temperature change of the material may be less affected by combustion temperatures than the first thickness of material 312. As such, water vapors in the combustion chamber may collect onto the material of the second thickness of material 316 before the first thickness of material 312 reaches the dew point temperature. Additionally or alternatively, in one example, the material of the second thickness of material 316 may comprise one or more surface features, such as etchings, ridges, and the like, that increase its surface area to allow it to capture more condensate and mitigate condensate flow to the first thickness of material 312

The fuel injector 300 may be installed within an engine assembly, such as the engine assembly 100 shown in FIG. 1, in place of the fuel injector 136. Although in FIG. 1 a single cylinder 124 is shown, the engine 120 may comprise any number of cylinders, such as 2, 3, 4, 5, 6, 8 or more than 8 cylinders. Each of the cylinders 124 may have one or more fuel injectors 300 positioned to inject fuel therein.

With reference to FIG. 4, the diesel injector 300 may be manufactured according to a method 400. The method 400 comprises a first step 402 in which the injector nozzle body 310 is formed. In particular, the injector nozzle body, including the first and second thicknesses of material 312, 316 which form the injector nozzle body 310, may be formed using a casing or forging process. In other words, the first and second thicknesses of material 312, 316 may be formed by the same manufacturing process. In some arrangements, the outer surface 310b of the injector nozzle body 310 may be formed, (e.g. shaped), using a machining process, (e.g. a Computer Numerical Control (CNC) machining process). For example, the outer surface 310b may be shaped using a milling process or an Electrical Discharge Machining (EDM) process, such as a spark erosion process.

The method 400 may further comprise a second step 404, in which the injection passage 314 for injecting fuel using the fuel injector is formed though the first thickness of material. The injection passage 314 may be formed using a machine process, e.g. a CNC machining process. For example, the injection 314 hole may be formed using a milling process or an EDM process, such as a spark erosion process.

The injection passage 314 may be formed such that a sharp edge, e.g. an edge free from chamfers and fillets, is formed at the opening 316 of the injection passage. As described above, the sharp edge may be suitable for facilitating a spray for fuel being projected from injection passage 314.

The method 400 may further comprise a third step 406, in which the second thickness of is shaped such that the second thickness of material is spaced apart from the opening 314a of the injection passage, e.g. in a radial direction of the injection passage 314. Additionally, the second thickness of material 316, e.g. the outer extent 316b of the second thickness of material, may be shaped in order to encourage condensation to form on the outer surface 310b. As described above, condensation forming on the outer surface 310b of the injector nozzle body is thereby positioned away from the opening 314a of the injection passage.

The second thickness of material 316 may be shaped using any of the machining processes mentioned above for forming the injection passage 314. For example, the second thickness of material 316 may be shaped using a CNC spark erosion process. In some arrangements, the second thickness of material 316 may be shaped using the same manufacturing process used to form the injection passage 314. Furthermore, in some arrangements, the second thickness of material 316 may be shaped at the same time, e.g. during the same manufacturing stage, as the injection passage 314 is formed. For example, the second thickness of material 316 may be shaped and the injection passage 314 may be formed using a single spark erosion process.

Alternatively, the second thickness of material 316 may be shaped and the injection passage may be formed using separate manufacturing steps and/or processes. For example, the second thickness of material 316 may be shaped after the injection passage 314 is formed, or the injection passage 314 may be formed after the second thickness of material 316 is shaped.

If the second thickness is shaped after the injection passage being formed, the second thickness of material may be shaped such that the length of the injection passage is a desired length, e.g. in order to provide a desired flow rate of fuel during an injection event, and such that the sharp edge is formed at the opening 316 of the injection passage. In some arrangements, the sharp edge may be formed during shaping of the second thickness of material.

In some arrangements, shaping the second thickness of material may comprise forming the clearance hole 318 through the second thickness of material. The shape of the clearance hole 318 may be based on a shape of the injection passage 314, in one example. More specifically, a diameter of the clearance hole 318 may be based on a diameter of the injection passage 314 such that the diameter of the clearance hole 318 is at least 1.1 to 4 times larger than the diameter of the injection passage 314. The diameter of the clearance hole relative to the injection passage 314 may be optimized to a size such that it is large enough to not affect the fuel injection while being small enough to decrease an amount of condensate that may reach the injection passage 314. In this way, the diameter of the clearance hole may be based on a diameter of a fuel injection spray exiting an extreme end of the clearance hole in the outer extend of the second thickness of material.

Thus, in one example, the diameter of the clearance hole may be based on one or more of a thickness of the second thickness of material, a diameter of the injection passage 314, and a diameter of the fuel injection spray.

In one example, the diameter of the clearance hole 318 is a fixed diameter. Additionally or alternatively, in one embodiment, the diameter of the clearance hole 318 may increase in a downstream direction relative to a direction of fuel flow therethrough. As such, the diameter of the clearance hole may increase from the inner extent of the second thickness of material to the outer extent of the second thickness of material.

The method may comprise a further step is which a layer of corrosion resistant material is formed on the outer surface of the injector nozzle body, e.g. over the outer extent 316b of the second thickness of material.

FIGS. 1-3B show example configurations with relative positioning of the various components. If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Further, elements shown intersecting one another may be referred to as intersecting elements or intersecting one another, in at least one example. Further still, an element shown within another element or shown outside of another element may be referred as such, in one example. It will be appreciated that one or more components referred to as being “substantially similar and/or identical” differ from one another according to manufacturing tolerances (e.g., within 1-5% deviation).

In this way, a fuel injector may comprise features that mitigate degradation due to condensate formation on an injection passage of the fuel injector. The features may include an outer material arranged proximally to an outlet of the injection passage shaped to block condensate from reaching the injection passage without adjusting a fuel injection pattern and rate from the injection passage. The technical effect of arranging the outer material around outlets of the injection passages extending through an inner material is to promote condensate formation on the outer material so that degradation of the injection passage is decreased and/or blocked, thereby maintaining engine power output and decreasing emissions. Additionally, a manufacturing cost may be reduced by only coating portions of the inner material where the injection passages are located with the second material. As such, portions of the inner material that do not comprise the injection passage may be free of the outer material and exposed to combustion chamber conditions. An embodiment of a diesel fuel injector for an internal combustion engine, the diesel fuel injector comprises an injector nozzle body comprising a first thickness of material with at least one of an injection passage shaped therein and configured to expel fuel to a combustion chamber, the first thickness of material is configured to contain fuel at an injection pressure of the diesel fuel injector and a second thickness of material arranged around only portions of the first thickness of material where the injection passage is located, the second thickness of material comprising a clearance hole shaped to allow fuel to flow therethrough.

A first example of the diesel fuel injector further comprises where the clearance hole extends through the second thickness of material, wherein the clearance hole is aligned with the injection passage along a shared central axis, the clearance hole comprises a diameter greater than a diameter of a fuel injection as it exits the injection passage.

A second example of the diesel fuel injector, optionally comprising the first example, further comprises where the second thickness of material is configured to block condensate from forming on the injection passage of the first thickness of material.

A third example of the diesel fuel injector, optionally including one or more of the previous examples, further comprises where the first and second thicknesses of material are integrally formed.

A fourth example of the diesel fuel injector, optionally including one or more of the previous examples, further comprises where the first and second thicknesses of material are formed from the same material.

A fifth example of the diesel fuel injector, optionally including one or more of the previous examples, further comprises where the first and second thicknesses of material are formed by the same manufacturing process.

A sixth example of the diesel fuel injector, optionally including one or more of the previous examples, further comprises where a sharp edge is formed at the opening of the injection passage, the sharp edge being perpendicular to a central axis of the injection passage.

A seventh example of the diesel fuel injector, optionally including one or more of the previous examples, further comprises where the depth and a diameter of the injection passage is configured such that a desired flow rate of fuel is injected during a fuel injection event.

An eighth example of the diesel fuel injector, optionally including one or more of the previous examples, further comprises where the thickness of the first thickness of material is equal to the depth of the injection passage.

A ninth example of the diesel fuel injector, optionally including one or more of the previous examples, further comprises where the second thickness of material is configured to be a sacrificial material and collect condensate in the combustion chamber to stop it from reaching the first thickness of material.

A tenth example of the diesel fuel injector, optionally including one or more of the previous examples, further comprises where the clearance hole is shaped such that it does not contact a fuel injection exiting the injection passage and flowing through the clearance hole.

An embodiment of a method of manufacturing a diesel fuel injector, the method comprises forming an injector nozzle body, the injector nozzle body comprising a first thickness of material and a second thickness of material, wherein the second thickness of material forms an outer surface of the injector nozzle body and wherein the first thickness of material shaped an interior space of the injector nozzle body and is configured to structurally contain fuel at an injection pressure of the diesel fuel injector in the interior space, forming an injection passage for injecting fuel using the fuel injector though the first thickness of material, and shaping the second thickness of material, such that the second thickness of material is spaced apart from the injection passage opening and where condensation forming on the outer surface of the injector nozzle body is positioned away from the opening of the injection passage.

A first example of the method further comprises where shaping the second thickness of material comprises forming a clearance hole though the second thickness of material, the clearance hole being aligned with the injection passage, the clearance hole having a greater diameter than a spray of fuel injected via the injection passage when the spray passes the outer surface of the injector nozzle body.

A second example of the method, optionally including the first example, further comprises where the injection passage is formed such that a sharp edge is formed at an opening for the injection passage for forming a spray of fuel, and wherein shaping the second thickness of material comprises arranging the second thickness of material on only portions of the first thickness of material where the injection passage is formed, and wherein portions of the first thickness of material without the injection passage and free of the second thickness of material are exposed to a combustion chamber.

A third example of the method, optionally including one or more of the previous examples, further comprises where forming a layer of corrosion resistant material on the outer surface of the second thickness of material.

An embodiment of a fuel injector, comprises an inner material shaping an interior volume of the fuel injector and comprising at least one injection passage shaped to flow fuel from the interior volume to a combustion chamber and an outer material arranged on only a portion of the inner material where the at least one injection passage is arranged. A first example of the fuel injector further comprises where the outer material comprises a clearance hole that spans an entire thickness of the outer material, wherein the clearance hole is shaped to receive a fuel injection from the at least one injection passage without adjusting a shape, a rate, or an angle of the fuel injection, further comprising where a diameter of the clearance hole is greater than a greatest diameter of the fuel injection. A second example of the fuel injector, optionally including the first example, further comprises where the outer material comprises a material different than the inner material, and wherein the outer material is corrosion resistant and configured to capture condensate in the combustion chamber.

A third example of the fuel injector, optionally including one or more of the previous examples, further includes where a remaining portion of the inner material free of the at least one injection passage is free of the outer material and exposed to the combustion chamber.

A fourth example of the fuel injector, optionally including one or more of the previous examples, further includes where the outer material is in face-sharing contact with only the portion of the inner material and does not contact fuel in the interior volume or from the at least one injection passage.

Note that the example control and estimation routines included herein can be used with various engine and/or vehicle system configurations. The control methods and routines disclosed herein may be stored as executable instructions in non-transitory memory and may be carried out by the control system including the controller in combination with the various sensors, actuators, and other engine hardware. The specific routines described herein may represent one or more of any number of processing strategies such as event-driven, interrupt-driven, multi-tasking, multi-threading, and the like. As such, various actions, operations, and/or functions illustrated may be performed in the sequence illustrated, in parallel, or in some cases omitted. Likewise, the order of processing is not necessarily required to achieve the features and advantages of the example embodiments described herein, but is provided for ease of illustration and description. One or more of the illustrated actions, operations and/or functions may be repeatedly performed depending on the particular strategy being used. Further, the described actions, operations and/or functions may graphically represent code to be programmed into non-transitory memory of the computer readable storage medium in the engine control system, where the described actions are carried out by executing the instructions in a system including the various engine hardware components in combination with the electronic controller.

It will be appreciated that the configurations and routines disclosed herein are exemplary in nature, and that these specific embodiments are not to be considered in a limiting sense, because numerous variations are possible. For example, the above technology can be applied to V-6, I-4, I-6, V-12, opposed 4, and other engine types. The subject matter of the present disclosure includes all novel and non-obvious combinations and sub-combinations of the various systems and configurations, and other features, functions, and/or properties disclosed herein.

As used herein, the term “approximately” is construed to mean plus or minus five percent of the range unless otherwise specified.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A diesel fuel injector for an internal combustion engine, the diesel fuel injector comprising:
an injector nozzle body comprising a first thickness of material with at least one of an injection passage shaped therein and configured to expel fuel to a combustion chamber, the first thickness of material is configured to contain fuel at an injection pressure of the diesel fuel injector; and
a second thickness of material arranged around only portions of the first thickness of material where the injection passage is located, the second thickness of material comprising a clearance hole shaped to allow fuel to flow therethrough.

2. The diesel fuel injector of claim 1, wherein the clearance hole extends through the second thickness of material, wherein the clearance hole is aligned with the injection passage along a shared central axis, the clearance hole comprises a diameter greater than a diameter of a fuel injection as it exits the injection passage.

3. The diesel fuel injector of claim 1, wherein the second thickness of material is configured to block condensate from forming on the injection passage of the first thickness of material.

4. The diesel fuel injector of claim 1, wherein the first and second thicknesses of material are integrally formed.

5. The diesel fuel injector of claim 1, wherein the first and second thicknesses of material are formed from the same material.

6. The diesel fuel injector of claim 1, wherein the first and second thicknesses of material are formed by the same manufacturing process.

7. The diesel fuel injector of claim 1, wherein a sharp edge is formed at the opening of the injection passage, the sharp edge being perpendicular to a central axis of the injection passage.

8. The diesel fuel injector of claim 1, wherein the depth and a diameter of the injection passage is configured such that a desired flow rate of fuel is injected during a fuel injection event.

9. The diesel fuel injector of claim 8, wherein the thickness of the first thickness of material is equal to the depth of the injection passage.

10. The diesel fuel injector of claim 1, wherein the second thickness of material is configured to be a sacrificial material and collect condensate in the combustion chamber to stop it from reaching the first thickness of material.

11. The diesel fuel injector of claim 1, wherein the clearance hole is shaped such that it does not contact a fuel injection exiting the injection passage and flowing through the clearance hole.

12. A method of manufacturing a diesel fuel injector, the method comprising:
forming an injector nozzle body, the injector nozzle body comprising a first thickness of material and a second thickness of material, wherein the second thickness of material forms an outer surface of the injector nozzle body and wherein the first thickness of material shaped an interior space of the injector nozzle body and is configured to structurally contain fuel at an injection pressure of the diesel fuel injector in the interior space;
forming an injection passage for injecting fuel using the fuel injector though the first thickness of material; and
shaping the second thickness of material, such that the second thickness of material is spaced apart from the injection passage opening and where condensation forming on the outer surface of the injector nozzle body is positioned away from the opening of the injection passage.

13. The method of claim 12, wherein shaping the second thickness of material comprises forming a clearance hole though the second thickness of material, the clearance hole being aligned with the injection passage, the clearance hole having a greater diameter than a spray of fuel injected via the injection passage when the spray passes the outer surface of the injector nozzle body.

14. The method of claim 12, wherein the injection passage is formed such that a sharp edge is formed at an opening for the injection passage for forming a spray of fuel, and wherein shaping the second thickness of material comprises arranging the second thickness of material on only portions of the first thickness of material where the injection passage is formed, and wherein portions of the first thickness of material without the injection passage and free of the second thickness of material are exposed to a combustion chamber.

15. The method of claim 12, further comprises forming a layer of corrosion resistant material on the outer surface of the second thickness of material.

16. A fuel injector, comprising:
an inner material shaping an interior volume of the fuel injector and comprising at least one injection passage shaped to flow fuel from the interior volume to a combustion chamber; and
an outer material arranged on only a portion of the inner material where the at least one injection passage is arranged.

17. The fuel injector of claim 16, wherein the outer material comprises a clearance hole that spans an entire thickness of the outer material, wherein the clearance hole is shaped to receive a fuel injection from the at least one injection passage without adjusting a shape, a rate, or an angle of the fuel injection, further comprising where a diameter of the clearance hole is greater than a greatest diameter of the fuel injection.

18. The fuel injector of claim 16, wherein the outer material comprises a material different than the inner material, and wherein the outer material is corrosion resistant and configured to capture condensate in the combustion chamber.

19. The fuel injector of claim 16, wherein a remaining portion of the inner material free of the at least one injection passage is free of the outer material and exposed to the combustion chamber.

20. The fuel injector of claim 16, wherein the outer material is in face-sharing contact with only the portion of the inner material and does not contact fuel in the interior volume or from the at least one injection passage.
